(19) United States
(12) Patent Application Publication
(10) Pub. No.: US 2025/0376825 A1
(43) Pub. Date: Dec. 11, 2025

(54) GATE LINKAGE CONTROL METHOD AND DEVICE AND SERIES WATER SUPPLY AND POWER GENERATION SYSTEM

(71) Applicants: CHINA THREE GORGES CORPORATION, Wuhan, Hubei (CN); CHINA INSTITUTE OF WATER RESOURCES AND HYDROPOWER RESEARCH, Beijing (CN)

(72) Inventors: Yizi SHANG, Beijing (CN); Lili LIANG, Beijing (CN); Xiaofei LI, Beijing (CN); Yuntao YE, Beijing (CN); Zhiwu LIU, Beijing (CN); Jiaguo GONG, Beijing (CN)

(73) Assignees: CHINA THREE GORGES CORPORATION, Wuhan, Hubei (CN); CHINA INSTITUTE OF WATER RESOURCES AND HYDROPOWER RESEARCH, Beijing (CN)

(21) Appl. No.: 18/729,347

(22) PCT Filed: Jul. 10, 2023
(86) PCT No.: PCT/CN2023/106649

§ 371 Date: Jul. 16, 2024

(30) Foreign Application Priority Data
Mar. 2, 2023 (CN) 202310194266.3

(51) Int. Cl. E02B 9/02; E02B 7/20

(52) U.S. Cl. CPC E02B 9/02; E02B 7/205

(57) ABSTRACT

A gate linkage control method and device and a series water supply and power generation system are provided. The method comprises the following steps of: acquiring a water demand and current water level information of the series water supply and power generation system, the current water level information at least comprising current riverway water level information and current water diversion trunk canal water level information; determining a gate opening degree control strategy of a first water diversion gate and a second water diversion gate according to the water demand and the current water level information of the series water supply and power generation system; and carrying out linkage control on the first water diversion gate and the second water diversion gate according to the gate opening degree control strategy.

### TECHNICAL FIELD

The present application relates to the technical field of automation control, and particularly to a gate linkage control method and device and a series water supply and power generation system.

### BACKGROUND

At present, an open canal water diversion and water supply project with the functions of water delivery, water distribution, power generation and safe operation is called a water supply-power generation canal, and also known as a water supply and power generation system. If guiding principles of safe water delivery, accurate water measurement, real-time project safety monitoring and scientific, timely and effective dispatching can be implemented, the efficient utilization of water energy and water resources can be realized while operating and managing the water supply project safely, reliably, economically and scientifically, so that there are obvious advantages. However, the operation control of the system involves many aspects such as hydrometeorology, water regime and water dispatching, and it is difficult to control the system stably. Therefore, how to control the system stably has become a key research content.

In the prior art, a staff usually estimates a target water level and a target flow velocity of a water diversion canal according to a water demand, and then control gate opening degrees of various gates in the water supply and power generation system. However, because the change of the water demand is random, multi-objective and real-time, the water supply and power generation system cannot be accurately controlled by the prior art.

### SUMMARY

The present application provides a gate linkage control method and device and a series water supply and power generation system, so as to overcome the defects in the prior art, for example, the water supply and power generation system cannot be accurately controlled.

As a first aspect of the present application, a gate linkage control method is proposed, applied to a series water supply and power generation system, the series water supply and power generation system comprising a reservoir, a riverway, an overflow weir and a water diversion trunk canal, one end of the riverway being connected with the reservoir, a first water diversion gate being arranged between the riverway and the reservoir, the riverway being sequentially provided with a tubular hydrogenerator set and the overflow weir in a water flow direction of the riverway, the water diversion trunk canal being arranged in parallel with the riverway in a downstream position of the riverway, and a second water diversion gate being arranged between the water diversion trunk canal and the overflow weir, wherein the method comprises the following steps of:
acquiring a water demand and current water level information of the series water supply and power generation system, wherein the current water level information at least comprises current riverway water level information and current water diversion trunk canal water level information;
determining a gate opening degree control strategy of a first water diversion gate and a second water diversion gate according to the water demand and the current water level information of the series water supply and power generation system;
carrying out linkage control on the first water diversion gate and the second water diversion gate according to the gate opening degree control strategy.

Optionally, the determining the gate opening degree control strategy of the first water diversion gate and the second water diversion gate according to the water demand and the current water level information of the series water supply and power generation system, comprises:
determining the gate opening degree control strategy of the first water diversion gate and the second water diversion gate according to water level and flow rate change trend information, the water demand and the current water level information of the series water supply and power generation system, wherein the riverway and the water diversion trunk canal are provided with a plurality of water level monitoring stations, and the water level and flow rate change trend information represents a corresponding relationship between a water level change and a flow rate of each water level monitoring station;
wherein, the water demand at least comprises a target water level of the water diversion trunk canal.

Optionally, the series water supply and power generation system comprises two water diversion trunk canals, the two water diversion trunk canals are located on two sides of the riverway, and are both arranged in parallel with the riverway in the downstream position of the riverway, and the second water diversion gate is arranged between each water diversion trunk canal and the overflow weir, and the determining the gate opening degree control strategy of the first water diversion gate and the second water diversion gate according to the water level and flow rate change trend information, the water demand and the current water level information of the series water supply and power generation system, comprises:
determining a water deficit of the water diversion trunk canal according to the water demand and the current water level information;
determining a primary gate opening degree control strategy of the first water diversion gate and the second water diversion gate according to the water deficit of the water diversion trunk canal and the water level and flow rate change trend information based on a linkage influence among various water diversion gates in the series water supply and power generation system;
acquiring environmental interference information of the series water supply and power generation system;
determining a system error of the series water supply and power generation system according to the environmental interference information,
determining a gate adjustment error according to a gate linkage control result represented by the primary gate opening degree control strategy of the first water diversion gate and the second water diversion gate;
correcting the primary gate opening degree control strategy of the first water diversion gate and the second water diversion gate according to the system error and the gate adjustment error to obtain the gate opening degree control strategy of the first water diversion gate and the second water diversion gate.

Optionally, the method further comprises the following step of:
determining the linkage influence among various water diversion gates in the series water supply and power generation system according to the following formula:

K₁(k+1)=αK₁(k)+βK₂(k)+γK₃(k)
wherein, K₁ represents the first water diversion gate, K₂ and K₃ respectively represent two second water diversion gates, K₁(k+1) represents a gate opening degree of the first water diversion gate at a moment k+1, K₁(k), K₂(k) and K₃(k) respectively represent gate opening degrees of the first water diversion gate and the two second water diversion gates at a moment k, and α, β and γ respectively represent flow rate indexes of the first water diversion gate and the two second water diversion gates at the moment k.

Optionally, the determining the gate adjustment error according to the gate linkage control result represented by the primary gate opening degree control strategy of the first water diversion gate and the second water diversion gate, comprises:
predicting the gate linkage control result according to the primary gate opening degree control strategy of the first water diversion gate and the second water diversion gate based on a hydrodynamic model and a large time delay control model of the series water supply and power generation system;
determining the gate adjustment error corresponding to the primary gate opening degree control strategy according to a water level difference between a predicted water level represented by the gate linkage control result and the target water level represented by the water demand.

Optionally, the acquiring the current water level information of the series water supply and power generation system, comprises:
acquiring a current water level monitoring result obtained by each water level monitoring station;
filtering the current water level monitoring result according to water level fluctuation information of the riverway and the water diversion trunk canal to obtain the current water level information of the series water supply and power generation system.

Optionally, the carrying out linkage control on the first water diversion gate and the second water diversion gate according to the gate opening degree control strategy, comprises:
carrying out linkage control on the first water diversion gate and the second water diversion gate according to the gate opening degree control strategy based on a preset canal time delay control model to make a water level of the water diversion trunk canal change stably, wherein the preset canal time delay control model is as follows:

$$\frac{d {c}_{i} ( t )}{dt} = \frac{1}{{A}_{hi}} [ {q}_{jini} ( t - {τ}_{i} ) - {q}_{chui} ( t ) - {q}_{qui} ( t ) ]$$

wherein, cᵢ(t) represents a deviation between an actual water level and a steady water level of a water diversion trunk canal i at a moment t, Aₕᵢ represents a backwater zone area of the water diversion trunk canal i, qⱼᵢₙᵢ, q_{chui} and q_{qui} respectively represent deviations of an inlet flow rate, an outlet flow rate and an intake flow rate corresponding to the water diversion trunk canal i in a steady state, and τᵢ represents a time delay corresponding to the water diversion trunk canal i.

As a second aspect of the present application, a gate linkage control device is proposed, applied to a series water supply and power generation system, the series water supply and power generation system comprising a reservoir, a riverway, an overflow weir and a water diversion trunk canal, one end of the riverway being connected with the reservoir, a first water diversion gate being arranged between the riverway and the reservoir, the riverway being sequentially provided with a tubular hydrogenerator set and the overflow weir in a water flow direction of the riverway, the water diversion trunk canal being arranged in parallel with the riverway in a downstream position of the riverway, and a second water diversion gate being arranged between the water diversion trunk canal and the overflow weir, wherein the device comprises:
an acquisition device configured for acquiring a water demand and current water level information of the series water supply and power generation system, wherein the current water level information at least comprises current riverway water level information and current water diversion trunk canal water level information;
a determination module configured for determining a gate opening degree control strategy of a first water diversion gate and a second water diversion gate according to the water demand and the current water level information of the series water supply and power generation system;
a control module configured for carrying out linkage control on the first water diversion gate and the second water diversion gate according to the gate opening degree control strategy.

As a third aspect of the present application, a series water supply and power generation system is proposed, the series water supply and power generation system comprises:
a reservoir, a riverway, an overflow weir and a water diversion trunk canal, wherein one end of the riverway is connected with the reservoir, and a first water diversion gate is arranged between the riverway and the reservoir;
the riverway is sequentially provided with a tubular hydrogenerator set and the overflow weir in a water flow direction of the riverway, the water diversion trunk canal is arranged in parallel with the riverway in a downstream position of the riverway, and a second water diversion gate is arranged between the water diversion trunk canal and the overflow weir;
further comprises an electronic device, wherein the electronic device comprises at least one processor and a storage;
the storage stores a computer executive instruction;
the at least one processor executes the computer executive instruction stored in the storage, so that the at least one processor executes the method described in the first aspect and the various possible designs of the first aspect.

As a fourth aspect of the present application, a computer-readable storage medium is also proposed, the computer-readable storage medium stores a computer executive instruction, and when executed by a processor, the computer executive instruction implements the gate linkage control method described in the first aspect and the various possible designs of the first aspect.

The technical solution of the present application bas the following advantages.

According to the gate linkage control method and device and the series water supply and power generation system provided by the present application, the method is applied to the series water supply and power generation system, the series water supply and power generation system comprises a reservoir, a riverway, an overflow weir and a water diversion trunk canal, one end of the riverway is connected with the reservoir, a first water diversion gate is arranged between the riverway and the reservoir, the riverway is sequentially provided with a tubular hydrogenerator set and the overflow weir in a water flow direction of the riverway, the water diversion trunk canal is arranged in parallel with the riverway in a downstream position of the riverway, and a second water diversion gate is arranged between the water diversion trunk canal and the overflow weir, and the method comprises the following steps of: acquiring a water demand and current water level information of the series water supply and power generation system, the current water level information at least comprising current riverway water level information and current water diversion trunk canal water level information; determining a gate opening degree control strategy of a first water diversion gate and a second water diversion gate according to the water demand and the current water level information of the series water supply and power generation system; and carrying out linkage control on the first water diversion gate and the second water diversion gate according to the gate opening degree control strategy. According to the method provided by the solution above, the gate opening degree control strategy is determined according to the current water demand and the current water level information, so that gate opening degrees of multiple water diversion gates can be controlled according to the gate opening degree control strategy, so as to accurately control the series water supply and power generation system.

### BRIEF DESCRIPTION OF THE DRAWINGS

The present invention is further described hereinafter with reference to the drawings and embodiments.

FIG. 1 is a flow chart of a gate linkage control method provided by an embodiment of the present application;

FIG. 2 is a flow chart of feedforward and feedback fusion control provided by the embodiment of the present application;

FIG. 3 is a schematic structural diagram of a gate linkage control device provided by the embodiment of the present application;

FIG. 4 is a schematic structural diagram of a series water supply and power generation system provided by the embodiment of the present application; and

FIG. S is a schematic structural diagram of an electronic device provided by the embodiment of the present application.

### DETAILED DESCRIPTION OF THE INVENTION

In order to make the objectives, the technical solutions and the advantages of the embodiments of the present application more clear, the technical solutions in the embodiments of the present application will be illustrated clearly and completely hereinafter with reference to the accompanying drawings in the embodiments of the present application. Apparently, the embodiments described are merely some but not all of the embodiments of the present application. Based on the embodiments of the present application, all other embodiments obtained by those of ordinary skills in the art without going through any creative work should fall within the scope of protection of the present application.

An embodiment of the present application provides a gate linkage control method, applied to a series water supply and power generation system and used for carrying out gate linkage control on the series water supply and power generation system. The series water supply and power generation system comprises a reservoir, a riverway, an overflow weir and a water diversion trunk canal, one end of the riverway is connected with the reservoir, a first water diversion gate is arranged between the riverway and the reservoir, the riverway is sequentially provided with a tubular hydrogenerator set and the overflow weir in a water flow direction of the riverway, the water diversion trunk canal is arranged in parallel with the riverway in a downstream position of the riverway, and a second water diversion gate is arranged between the water diversion trunk canal and the overflow weir. An executive body of the embodiment of the present application is an electronic device, such as a server, a desktop computer, a notebook computer, a tablet computer and other electronic devices capable of being used for automation control of the gates.

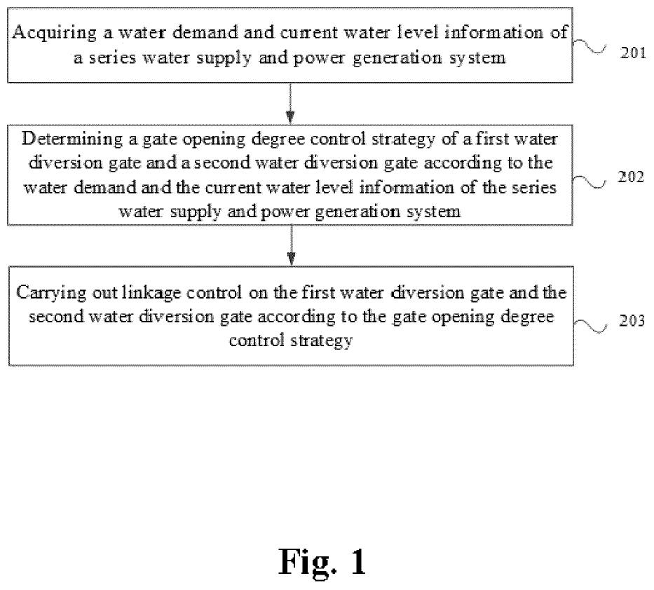

FIG. 1 is a flow chart of the gate linkage control method provided by the embodiment of the present application, and the method comprises the following steps.

In step 101, a water demand and current water level information of the series water supply and power generation system are acquired.

The current water level information at least comprises current riverway water level information and current water diversion trunk canal water level information.

In step 102, a gate opening degree control strategy of a first water diversion gate and a second water diversion gate are determined according to the water demand and the current water level information of the series water supply and power generation system.

Specifically, in order to ensure the reliability of the gate opening degree control strategy, a feedforward adjustment and a feedback adjustment may be fused to determine the gate opening degree control strategy of the first water diversion gate and the second water diversion gate according to the water demand and the current water level information of the series water supply and power generation system.

Specifically, in one embodiment, the gate opening degree control strategy of the first water diversion gate and the second water diversion gate may be determined according to water level and flow rate change trend information, the water demand and the current water level information of the series water supply and power generation system.

The riverway and the water diversion trunk canal are provided with a plurality of water level monitoring stations, and the water level and flow rate change trend information represents a corresponding relationship between a water level change and a flow rate of each water level monitoring station; and the water demand at least comprises a target water level of the water diversion trunk canal.

It should be noted that, in view of the fact that the flowing of a water flow takes time, and the water flow itself occupies a volume and needs to be accommodated, an action should be taken for this when the water flow is expected to arrive, so as to avoid inappropriate time when an adjustment is made after the water flow is found and occurs. Therefore, predictive control may be formed according to a model to predict a change occurring trend state of a water level and a flow rate, thus further determining the relationship between the water level and the flow rate, wherein the water flow will definitely flow to the water level monitoring station and the water diversion gate, but the flowing will take some time actually, and the water level and flow rate change trend information can at least determine time when the water level changes under an influence of a change of the flow rate. The gate opening degree control strategy is determined in combination with the water level and flow rate change trend information of the series water supply and power generation system, so as to avoid a loss or backwater of the water flow, thus further guaranteeing the safety of the series water supply and power generation system.

In step 103, linkage control is carried out on the first water diversion gate and the second water diversion gate according to the gate opening degree control strategy.

It should be noted that the gate opening degree control strategy at least comprises target opening degrees and opening degree transition processes of the first water diversion gate and the second water diversion gate.

Specifically, linkage control may be carried out on the first water diversion gate and the second water diversion gate according to the target opening degrees and the opening degree transition processes of the first water diversion gate and the second water diversion gate represented by the gate opening degree control strategy.

In one embodiment, in order to ensure a stable change of the water level of the water diversion trunk canal in a control process, so as to ensure the safety of the series water supply and power generation system, linkage control may be carried out on the first water diversion gate and the second water diversion gate according to the gate opening degree control strategy based on a preset canal time delay control model to make the water level of the water diversion trunk canal change stably, wherein the preset canal time delay control model is as follows:

$$\frac{d {c}_{i} ( t )}{dt} = \frac{1}{{A}_{hi}} [ {q}_{jini} ( t - {τ}_{i} ) - {q}_{chui} ( t ) - {q}_{qui} ( t ) ]$$

wherein, cᵢ(t) represents a deviation between an actual water level and a steady water level of a water diversion trunk canal i at a moment t, Aₕᵢ represents a backwater zone area of the water diversion trunk canal i, qⱼᵢₙᵢ, q_{chui} and q_{qui} respectively represent deviations of an inlet flow rate, an outlet flow rate and an intake flow rate corresponding to the water diversion trunk canal i in a steady state, and τᵢ represents a time delay corresponding to the water diversion trunk canal i.

Specifically, in the process of carrying out linkage control on the first water diversion gate and the second water diversion gate according to the gate opening degree control strategy,

$$\frac{d {c}_{i} ( t )}{dt}$$

is ensured to be kept within a preset safety range.

Based on the above embodiment, as an implementable way, in one embodiment, the series water supply and power generation system comprises two water diversion trunk canals, the two water diversion trunk canals are located on two sides of the riverway, and are both arranged in parallel with the riverway in the downstream position of the riverway, and the second water diversion gate is arranged between each water diversion trunk canal and the overflow weir, and the determining the gate opening degree control strategy of the first water diversion gate and the second water diversion gate according to the water level and flow rate change trend information, the water demand and the current water level information of the series water supply and power generation system, comprises:
step 1021: determining a water deficit of the water diversion trunk canal according to the water demand and the current water level information;
step 1022: determining a primary gate opening degree control strategy of the first water diversion gate and the second water diversion gate according to the water deficit of the water diversion trunk canal and the water level and flow rate change trend information based on a linkage influence among various water diversion gates in the series water supply and power generation system,
step 1023: acquiring environmental interference information of the series water supply and power generation system;
step 1024: determining a system error of the series water supply and power generation system according to the environmental interference information;
step 1025: determining a gate adjustment error according to a gate linkage control result represented by the primary gate opening degree control strategy of the first water diversion gate and the second water diversion gate;
step 1026: correcting the primary gate opening degree control strategy of the first water diversion gate and the second water diversion gate according to the system error and the gate adjustment error to obtain the gate opening degree control strategy of the first water diversion gate and the second water diversion gate.

Specifically, the linkage influence among various water diversion gates in the series water supply and power generation system may be determined according to a positional relationship among various water diversion gates and a topographic factor of the series water supply and power generation system, and the linkage influence among various water diversion gates is mainly manifested in a gate opening degree influence and a flow rate influence. The environmental interference information of the series water supply and power generation system is mainly meteorological information of the series water supply and power generation system, such as evaporation and precipitation of water.

Specifically, in one embodiment, the linkage influence among various water diversion gates in the series water supply and power generation system may be determined according to the following formula:

$${K}_{1} ( k + 1 ) = α {K}_{1} ( k ) + β {K}_{2} ( k ) + γ {K}_{3} ( k )$$

wherein, K₁ represents the first water diversion gate, K₂ and K₃ respectively represent two second water diversion gates, K₁(k+1) represents a gate opening degree of the first water diversion gate at a moment k+1, K₁(k), K₂(k) and K₃(k) respectively represent gate opening degrees of the first water diversion gate and the two second water diversion gates at a moment k, and α, β and γ respectively represent flow rate indexes of the first water diversion gate and the two second water diversion gates at the moment k.

It should be noted that the feedforward adjustment is not suitable for steady-state maintenance and fine tuning in daily application, so that feedforward and feedback control systems are combined to compensate for the inaccuracy and partial unpredictability of the feedforward adjustment, which also avoids a negative influence that a steady-state position tracking error caused by a system fluctuation behind an interference brought by deviation control of a single feedback control system finally affects a final motion trajectory of the system.

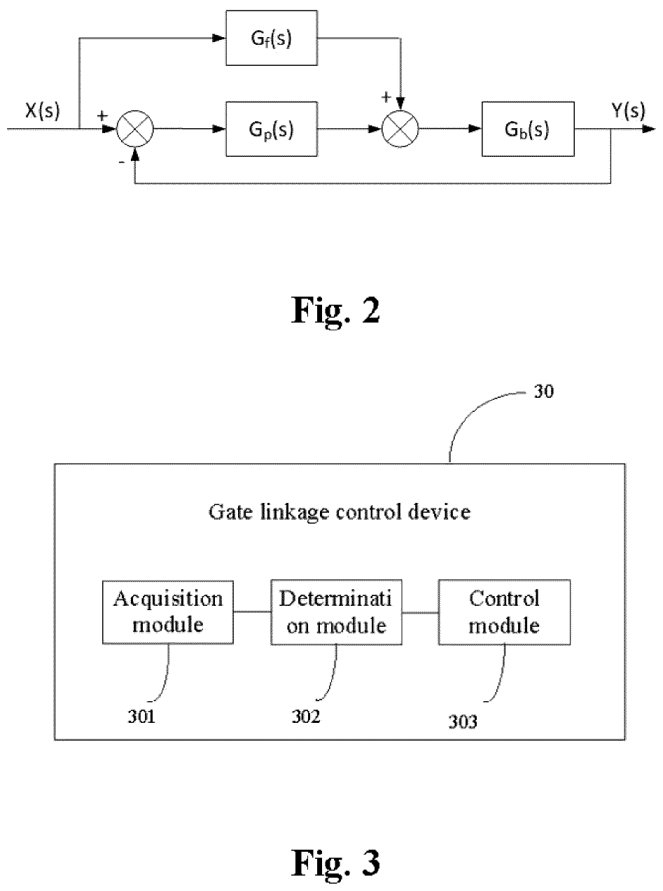

Specifically, the gate opening degree control strategy may be determined by a feedforward adjustment and feedback adjustment fusion method. FIG. 2 is a flow chart of feedforward and feedback fusion control provided by the embodiment of the present application. The feedforward adjustment is defined as adjusting according to a disturbance (the water deficit) itself, and the feedback adjustment is defined as adjusting according to a deviation between a current state and a specified mechanism.

Specifically, the opening degree of the water diversion gate is set as an input u1, and assuming that an initial opening degree u1=0 represents that the gate is in a closed state, there is:

$$Ψ ( s ) = {Ψ}_{1} ( s ) + {Ψ}_{2} ( s ) = [ {D}_{n} ( s ) G ( s ) + {G}_{n} ( s ) ] N ( s )$$

wherein, Ψ(s) represents the occurrence of a disturbance η, and then under an action of control U, influences Ψ₁ and Ψ₂ produced by the control are respectively superposed and then output; Dₙ(s) is a function of the feedforward adjustment, and Gₙ(s) represents an influence transfer function caused by the disturbance η in a process of generation and transmission; and N(s) represents a transfer function of an effect of combined feedforward adjustment and feedback adjustment.

Ideally, Ψ(s)=0, that is:

$${D}_{n} ( s ) G ( s ) + {G}_{n} ( s ) = 0$$

Then, a transfer function of a feedforward adjuster herein is obtained:

$${D}_{n} ( s ) = - {G}_{n} ( s ) / G ( s )$$

wherein, G(s) represents a transfer function of a control process in the water diversion canal.

In combined with the feedforward adjustment and the feedback adjustment, a controller with both an open loop and a closed loop is formed, X(s) represents a current working condition (the water demand and the current water level information), G_{f}(s) represents a measured value input by a control system of the feedforward adjuster, which is automatically controlled, then an adjustment error and a system error generated are continuously input into the controller to continue the adjustment control, and finally, an executive mechanism application strategy Y(s) of the series linkage control system is output.

A transfer function of the output Y(s) to the input X(s) of the system is:

$${G}_{0} ( s ) = \frac{Y ( s )}{X ( s )} = \frac{{G}_{p} ( s ) {G}_{b} ( s ) + {G}_{f} ( s ) {G}_{b} ( s )}{1 + {G}_{p} ( s ) {G}_{b} ( s )}$$

wherein, Gₚ(s) serves as a feedback transfer function in the controller with both the open loop and the closed loop, and G_{b}(s) serves as a transfer function combining open loop and closed loop effects in the controller.

The obtained system error is:

$$E ( s ) = X ( s ) - Y ( s )$$

A transfer function of the system error to the input is:

$$G ( s ) = \frac{E ( s )}{X ( s )} = \frac{1 - {G}_{f} ( s ) {G}_{b} ( s )}{1 + {G}_{p} ( s ) {G}_{b} ( s )}$$

Specifically, in one embodiment, the gate linkage control result may be predicted according to the primary gate opening degree control strategy of the first water diversion gate and the second water diversion gate based on a hydrodynamic model and a large time delay control model of the series water supply and power generation system; and the gate adjustment error corresponding to the primary gate opening degree control strategy is determined according to a water level difference between a predicted water level represented by the gate linkage control result and a target water level represented by the water demand.

Specifically, concepts of linkage control and digital twin verification are fused, the large time delay control model under the guidance of prediction is formed in combination with the simulation of the hydrodynamic model, and conversion is carried out according to an adjustment system model through verification and correction of time delay and deviation tracking. The simulation of the hydrodynamic model is applied continuously, and a feedback is made to the controller in combination with a real-time opening degree feedback and a water level change trend. Meanwhile, a measurement difference, a simulation difference and a control difference are corrected, and a digital twin model is corrected in real time based on actually measured values of water levels, flow rates and actual gate opening degrees of the riverway and the water diversion trunk canal, an opening degree guidance is issued after adjustment, the linkage control is a whole formed according to the water flow, the change of the water flow needs to be adjusted by upstream and downstream gates together to restore a deviation to a normal state. Combined with an influence of transfer time, the cohesion and coordination of the gates in a cooperation process is ensured. The prediction of the hydrodynamic model is continued, followed by the feedback and then the adjustment, and after current verification is correct, a strategy guidance for gate opening degree control is obtained, until a stable value specified by a mechanism is recovered. A final mechanism-driven linkage control strategy is formed, and an opening degree, opening and closing guidance and an operation time strategy for each gate of the linkage control are formed.

Further, in one embodiment, the linkage control may be carried out on the first water diversion gate and the second water diversion gate according to the gate opening degree control strategy based on a preset canal time delay control model to make a water level of the water diversion trunk canal change stably, wherein the preset canal time delay control model is as follows:

$$\frac{d {c}_{i} ( t )}{dt} = \frac{1}{{A}_{hi}} [ {q}_{jini} ( t - {τ}_{i} ) - {q}_{chui} ( t ) - {q}_{qui} ( t ) ]$$

wherein, cᵢ(t) represents a deviation between an actual water level and a steady water level of a water diversion trunk canal i at a moment t, Aₕᵢ represents a backwater zone area of the water diversion trunk canal i, qⱼᵢₙᵢ, q_{chui} and q_{qui} respectively represent deviations of an inlet flow rate, an outlet flow rate and an intake flow rate corresponding to the water diversion trunk canal i in a steady state, and τᵢ represents a time delay corresponding to the water diversion trunk canal i.

On the basis of the above embodiment, in order to ensure the reliability of acquired data, as an implementable way, in one embodiment, the acquiring the current water level information of the series water supply and power generation system, comprises:
step 1011: acquiring a current water level monitoring result obtained by each water level monitoring station;
step 1012: filtering the current water level monitoring result according to water level fluctuation information of the riverway and the water diversion trunk canal to obtain the current water level information of the series water supply and power generation system.

Specifically, considering that the water level fluctuates, and the water level under unsteady control itself is dynamic, changing and fluctuating, in order to ensure the reliability of acquired data, initial water level information (a current water level monitoring result) is filtered to realize data denoising, so that a filtering technology is introduced, and application methods comprise but are not limited to ADRC active disturbance rejection control, a clipping filtering method, a median filtering method, an arithmetic average filtering method, a recursive average filtering method, a median average filtering method, a clipping average filtering method, a debounce filtering method, a Kalman filtering method, and the like. The real-time current water level monitoring result is used as an input to deal with a disturbance and a deviation in a monitoring process. Accurate water level information without disturbance and noise may be obtained by processing measured data through active disturbance rejection and filtering algorithms, which supports subsequent control and learning.

Specifically, in one embodiment, the ADRC active disturbance rejection control method may be used to monitor water level monitoring stations in positions of three water diversion gates in real time:

$${C}_{1} ( t ) = C ( t ) \\ {C}_{2} ( t ) = \dot{C} ( t ) = \frac{{tj}_{x} - {tj}_{g}}{{T}_{ab}} C ( t ) + \frac{{tj}_{y}}{{T}_{ab}} {S}_{1} ( t - τ ) + \frac{{e}_{h}}{{T}_{ab}} {S}_{2} ( t ) - \frac{1}{{T}_{ab}} {m}_{df} \\ {C}_{3} ( t ) = \ddot{C} ( t ) = \frac{{( {tj}_{x} - {tj}_{g} )}^{2}}{{T}_{ab}^{2}} C ( t ) + \frac{{tj}_{y} {e}_{qh} ( {tj}_{x} - {tj}_{g} ) + {e}_{qy} {T}_{ab}^{2} - {tj}_{y} {e}_{qh} {T}_{ab}}{{e}_{qh} {T}_{ab}^{2} {T}_{y}} {S}_{1} ( t - τ ) + \frac{{e}_{h} {e}_{qh} ( {tj}_{x} - {tj}_{g} ) {T}_{w} - {T}_{ab}^{2}}{{e}_{qh} {T}_{ab}^{2} {T}_{w}} {S}_{2} ( t ) - \frac{{tj}_{x} - {tj}_{g}}{{T}_{ab}^{2}} {m}_{df} + \frac{{e}_{y} {e}_{qh} - {e}_{qy} {T}_{ab}}{{e}_{qh} {T}_{y} {T}_{ab}} u ( t )$$

wherein, C₁, C₂ and C₃ respectively represent state variables obtained by the active disturbance rejection algorithm, that is, water level information of the water level monitoring stations corresponding to the three water diversion gates at a moment t, and T_{ab} represents an inertia time constant of gate linkage control; tjₓ, tj_{g} and tj_{y} are constants of self-adjusting coefficients, zkₕ, zke_{q} and zkₗ represent constants of active disturbance rejection coefficients, m_{df} represents a large-amplitude and heavy-load fluctuation, S is a real-time input signal, that is, a water level monitoring result at the moment t, S1 is an approximate input extracted by a differential tracker, and S2 is a differential signal; and Ċ and \ddot{C} are used for measuring relative deviations between output current canal water level and flow rate and actual values.

Specifically, in one embodiment, before the gate linkage control is carried out on the series water supply and power generation system, a prototype model of a series water supply and power generation system structure may be created based on a digital twin concept. Existing three-dimensional hydrodynamic models, comprising but being not limited to MIKE21, Hydro Qual, Fluent, and the like, are applied in combination with basic continuity equation, momentum equation, energy equation, and the like, and on this basis, a corresponding system function of a device in the series water supply and power generation system is added, and a verification mechanism for a form and function of the model is improved, so that a simulated operation of an initial canal structure is accurately and practically reflected in a virtual space. Then, a current structure is verified, and the accuracy of water level and flow rate measurement is verified through the established hydrodynamic model and a model test before the layout of monitoring points is finally formed. On the basis of a monitoring station type determined by a preliminary device structure scheme, a control variable test method is applied to test whether measured values of initial monitoring station sites are accurate when the canal has different water levels, flow rates and states and whether a situation of a current overall system can be reflected by these limited data respectively. Meanwhile, in view of whether canal assemblies are arranged reasonably, it is verified whether the control operation of the canal is feasible under different working conditions, and whether a canal control device system can realize coordination and cohesion when different working conditions are faced successively.

Further, in a feedback adjustment process, according to deviations between simulation test results and actually expected measurement accuracy and control effect, some measures need to be taken, comprising but being not limited to: optimization, improvement and selection of the monitoring site type, re-layout of the monitoring station site, adjustment of the control device in position and structure, and the like. After one stage of adjustment is completed according to a current model simulation feedback, the next stage of simulation is continuously implemented, feedback and adjustment are continually carried out, and this process is continued until a position of the monitoring station can accurately describe the working condition of the whole system and the device structure can cope with and cohere with different working conditions and canal states. A specification is strictly checked in the process, so that a frame design of its own structure and a design of a linkage control platform are formed, and an optimization scheme and an implementation way are pointed out, that is, the monitoring station site accurately meets actual needs, the linkage of business functions is formed between devices mainly used in gate control and the monitoring station, and the device cooperation and the cohesion and coordination of water supply-power generation series linkage in a control and application process are realized.

Specifically, the digital twin method is used to improve the hydrodynamic model for canal gate control, which specifically comprises:

taking a gate discharge equation as a boundary condition of a St. Venant equation set, incrementally linearizing the St. Venant equation set at a stable point by a Preissmann implicit difference scheme, constructing a state space model of a whole canal, and allowing a coupling relationship between canals and basins to be implicit in the model; and transforming the St. Venant equation set, comprising two sub-equations of a continuous equation and a momentum equation, discretizing the continuous equation and the momentum equation respectively, incrementally linearizing the equations at a steady-state working point, and transforming the continuous equation by a Pressimann four-node eccentric scheme:

$$\frac{{A}_{j + 1}^{n + 1} + {A}_{j}^{n + 1}}{2 Δ t} - \frac{{A}_{j + 1}^{n} + {A}_{j}^{n}}{2 Δ t} + \frac{θ}{Δ x} ( {Q}_{j + 1}^{n + 1} - {Q}_{j}^{n + 1} ) + \frac{1 - θ}{Δ x} ( {Q}_{j + 1}^{n} - {Q}_{j}^{n} ) = \frac{θ}{2} ( {q}_{j + 1}^{n + 1} + {q}_{j}^{n + 1} ) + \frac{1 - θ}{2} ( {q}_{j + 1}^{n} + {q}_{j}^{n} )$$

wherein, A is a discharge section area,

$${A}_{j + 1}^{n + 1}$$

is a discharge area of a node j+1 in an n+1 cycle step,

$${A}_{j}^{n + 1}$$

is a discharge area of a node j+1 in an n+1 cycle step,

$${A}_{j + 1}^{n}$$

is a discharge area of the node j+1 in an n cycle step, and

$${A}_{j}^{n}$$

is a discharge area of a node j+1 in the n cycle step; Δt represents a time step, and Δx represents a space step; Q is a discharge flow rate,

$${Q}_{j + 1}^{n + 1}$$

is a discharge flow rate of the node j+1 in the n+1 cycle step,

$${Q}_{j}^{n + 1}$$

is a discharge flow rate of the node j in the n+1 cycle step,

$${Q}_{j + 1}^{n}$$

is a discharge flow rate of the node j+1 in the n+1 cycle step, and

$${Q}_{j}^{n}$$

is a discharge flow rate of the node j in the n cycle step; θ is an included angle between a lower edge tangent of a radial gate and a horizontal direction; and q is a lateral outflow rate per unit length of the canal,

$${q}_{j + 1}^{n + 1}$$

is a discharge flow rate of the node j+1 in the n+1 cycle step,

$${q}_{j}^{n + 1}$$

is a discharge flow rate of the node j in the n+1 cycle step,

$${q}_{j + 1}^{n}$$

is a discharge flow rate of the node j+1 in the n cycle step,

$${q}_{j}^{n}$$

is a discharge flow rate of the node j in the n cycle step, and assuming that

$${q}_{j + 1}^{n + 1} = {q}_{j}^{n + 1} = {q}_{j + 1}^{n} = {q}_{j}^{n} = {q}_{je} , {q}_{je}$$

represents a lateral outflow rate per unit length at the node J under a stable working condition.

When the steady-state working point of the canal is set as e, then:

$${Q}^{+} = {Q}_{ε}^{+} + δ {Q}^{+} \\ {Z}^{+} = {Z}_{ε}^{+} + δ {Z}^{+}$$

wherein, a discharge flow rate Qⁿ⁺¹ in the n+1 cycle step is briefly recorded as Q⁺, and δQ⁺ and δZ⁺ are respectively small deviations of a flow rate Q⁺_{ε} and a water level Z⁺_{ε} corresponding to a canal balance point.

Assuming that a discharge area Aⱼ of the node j is Aⱼ=BⱼδZⱼ, incremental linearization is expressed as:

$$\frac{{B}_{j}}{2 Δ t} ( δ {Z}_{j + 1}^{+} + {Z}_{j}^{+} ) - \frac{{B}_{j + 1}}{2 Δ t} ( {A}_{j + 1} + {A}_{j} ) + \frac{θ}{Δ x} ( δ {Q}_{j + 1}^{+} - δ {Q}_{j}^{+} ) + \frac{1 - θ}{Δ x} ( δ {Q}_{j + 1} - δ {Q}_{j} ) = - \frac{{Q}_{j + 1} - {Q}_{j}}{Δ x} + {q}_{je}$$

wherein, Bⱼ represents a width of the node j, Aⱼ₊₁ and Aⱼ respectively represent discharge areas of the node j+1 and the node j, and δZⱼ represents a small deviation of a balance water level of the node j.

A time-domain momentum equation is discretized by the Pressimann four-node eccentric scheme, the incremental linearization is made at the steady-state working point e, and an existing momentum equation is improved and transformed into:

$$\frac{\partial Q}{\partial t} = - 2 \frac{Q}{A} \frac{\partial Q}{\partial x} + {( \frac{Q}{A} )}^{2} \frac{\partial A}{\partial x} - \frac{\vert Q \vert Qg {κ}^{2}}{{AR}^{\frac{4}{3}}} + g ( θ - \frac{\partial Z}{\partial x} ) A$$

wherein, R is a hydraulic radius, x represents a distance, T represents time, a gravitational acceleration G is used to calculate an impulse, κ represents a constant for calculating a momentum, and Z represents a water head.

Specifically, in one embodiment, in order to further improve the accuracy of gate linkage control, after the feedforward adjustment and the feedback adjustment are fused to form model-based gate linkage control, a parameterized scheme under mechanism-driven control may be taken as a sample for supervised learning, water level values of each sample at multiple points of the same moment in a control process are taken as independent variables, corresponding gate control guidances are taken as dependent variables, and a regression analysis method is applied to form an output of a continuous mapping relationship between independent variables and dependent variables. In classification, an input is classified and layered, and discrete linkage control guidances are output.

Based on a tracking differentiator of a fhan function, an output signal is applied to quickly track an original signal without overshoot to form closed-loop control of an observer, and allowing that e(t)=X₁(t)−X(t), a discrete form is expressed as:

$$fh = fhan ( ω , X , r , {h}_{0} ) \\ {X}_{1} ( t + 1 ) = {X}_{1} ( t ) + σ {X}_{2} ( t ) \\ {X}_{2} ( t + 1 ) = {X}_{2} ( t ) + hfh$$

wherein, fh is a discrete expression form of the differential tracker, ω is an error signal, X₁ and X₂ are respectively an input signal and a differential observation signal acquired by the differential tracker, r is a speed factor of the fhan function, h₀ is a filtering factor, and σ is a sampling period.

In the above formula, fhan(ω,X,r,h₀) is determined as:

$$d = {rh}_{0}^{2} \\ n = {n}_{1} + {a}_{0} \\ {a}_{1} = \sqrt{d ( d + 8 \vert n \vert )} \\ {a}_{2} = {a}_{0} + sign ( y ) ( {a}_{1} - d ) / 2 \\ a = ( {a}_{0} + n - {a}_{2} ) {s}_{n} + {a}_{2} \\ {s}_{a} = ( sign ( a + d ) - sign ( a - d ) ) / 2 \\ fhan = - r [ \frac{a}{d} - sign ( a ) ] {s}_{a} - r sign ( a )$$

wherein, d is a sampling parameter of the fhan function, a is a relative deviation factor, a₀, a₁, and a₂ are all deviation factors in a filtering process, n is a disturbance quantity, n₁ is a difference value caused by a disturbance factor, sign is a nonlinear symbolic function of convergence analysis after an active-disturbance-rejection system reaches stability, sₙ is a state stability value calculated by the disturbance factors, and sₐ is a state stability value calculated by the deviation factor.

In combination with a model simulation application of a canal prototype system, the feedback is added for adjustment and improvement, a state space of the canal is obtained from different inputs and outputs of the sample, an expression of the state space corresponding to the canal system is described, the state space is continuously taken as a controlled model object to be subjected to simulated control, and a guidance is output for gate control.

A regression model is applied to quantitatively describe a statistical relationship between the input and the output in the sample, and testing, feedback and adjustment are carried out to form regression-prediction analysis, a statistical test and a specific question significance test.

Regression verification is continuously applied in a state space model to obtain parameters of a prediction function, simulation, calculation and feedback adjustment are carried out to verify and finally determine the parameters of the prediction function to obtain a prediction model, and the water level is taken as the input to predict a subsequent water level and flow rate change trend after the control strategy is applied. For the state space model of the canal system, water level and flow rate equations are obtained for the gate according to the conservation of water flow quality and a gate outflow formula:

$${Q}_{j} = {Q}_{j + 1} = {Q}_{g} \\ {Q}_{g} = {C}_{d} bu \sqrt{2 g Δ h} = f ( {Z}_{j} , {Z}_{j + 1} , u )$$

wherein, Q_{g} is a discharge flow rate, f( ) represents a water level and flow rate functional equation, C_{d} is a flow rate coefficient of a gate hole, u is a gate opening degree, b is a width of the gate hole, and Δh represents a water level difference.

The water level and flow rate equation is incrementally linearized:

$$- {( \frac{\partial f}{\partial {Z}_{j}} )}_{ε} δ {Z}_{j}^{+} + δ {Q}_{j + 1}^{+} - {( \frac{\partial f}{\partial {Z}_{j + 1}} )}_{ε} δ {Z}_{j + 1}^{+} = - {( \frac{\partial f}{\partial {Z}_{j}} )}_{ε} δ {z}_{j} + δ {Q}_{j + 1} - {( \frac{\partial f}{\partial {Z}_{j + 1}} )}_{ε} δ {Z}_{j + 1} + {( \frac{\partial f}{\partial u} )}_{ε} δ u$$

A prediction model of a corresponding matrix solution based on the state space is introduced into a model transformation space to obtain application guidance mechanisms of the prediction model and the corresponding control executive mechanism:

$${L}^{1} δ x ( k + 1 ) = {R}^{1} δ x ( k ) + P δ u ( k )$$

in the formula:

$${L}^{1} = ( \begin{matrix}{O}_{11} & {O}_{12} & {O}_{13} \\ {O}_{21} & {O}_{22} & {O}_{23} \\ {O}_{31} & {O}_{32} & {O}_{33}\end{matrix} ) \\ δ x ( k + 1 ) = {[ \begin{matrix}δ {Q}_{j}^{+} & δ {Z}_{j}^{+} & δ {Q}_{j + 1}^{+} & δ {Z}_{j + 1}^{+}\end{matrix} ]}^{T} \\ P = {[ {( \frac{\partial f}{\partial u} )}_{ε} ]}^{T} \\ {R}^{1} = ( \begin{matrix}{O}_{11}^{′} & {O}_{12}^{′} & {O}_{13}^{′} \\ {O}_{21}^{′} & {O}_{22}^{′} & {O}_{23}^{′} \\ {O}_{31}^{′} & {O}_{32}^{′} & {O}_{33}^{′}\end{matrix} ) \\ δ x ( k ) = {[ \begin{matrix}δ {Q}_{j} & δ {Z}_{j} & δ {Q}_{j + 1} & δ {Z}_{j + 1}\end{matrix} ]}^{T} \\ δ u ( k ) = {[ δ u ]}^{T}$$

wherein, L¹ represents a coefficient matrix of a predicted state of the canal system mapped to an influence effect, δx(k+1) represents a monitoring and perception data set of the water level, the flow rate and the gate opening degree when there is a small deviation between the state and the steady state of the canal system (the series water supply and power generation system) at a moment k+1, δx(k) represents a monitoring and perception data set of the water level, the flow rate and the gate opening degree when there is a small deviation between the state and the steady state of the canal system at a moment k, R¹ represents an influence effect mapping coefficient matrix of a current state of the canal system, P represents a comprehensive influence coefficient matrix of the opening degree, the flow rate and the water level under time delay control, and δu(k) represents an opening degree application strategy of a corresponding gate when multiple control executive mechanisms in the canal system provided by the embodiment of the present application are located in different positions.

A disturbance term is processed, and when the nodes j and j+1 are respectively set as front and back nodes of a water diversion port, and Qₚ is set as a water diversion flow rate of the water diversion port, water level and flow rate relationships between the nodes j and j+1 are as follows:

$${Q}_{j} - {Q}_{p} = {Q}_{j + 1} \\ {Z}_{j + 1} = {Z}_{j}$$

The prediction mode of the corresponding matrix solution is continuously introduced into the model transformation space based on the state space to be applied:

$${L}^{2} δ x ( k + 1 ) = {R}^{3} δ x ( k ) + W δ q ( k )$$

in the above formula:

$${L}^{2} = [ \begin{matrix}0 & - {( \frac{\partial f}{\partial {Z}_{j + 1}} )}_{ε} & 1 & - {( \frac{\partial f}{\partial {Z}_{j + 2}} )}_{ε}\end{matrix} ] \\ {R}^{2} = [ \begin{matrix}0 & - {( \frac{\partial f}{\partial {Z}_{j + 1}} )}_{ε}^{′} & 1 & - {( \frac{\partial f}{\partial {Z}_{j + 2}} )}_{ε}^{′}\end{matrix} ] \\ W = {[ \begin{matrix}{O}_{11} & - {P}_{11} \\ {O}_{21} & - {P}_{21}\end{matrix} ]}^{T} \\ δ q ( k ) = {[ \begin{matrix}δ {Q}_{p} & δ {Q}_{p}^{+}\end{matrix} ]}^{T}$$

wherein, L² represents a coefficient matrix of an influence of a predicted state of control and application of the canal system on the water level and the flow rate, R² represents a coefficient matrix of an influence of a current state of control and application of the canal system on the water level and the flow rate, W represents a comprehensive influence coefficient matrix of a lateral outflow rate on the system under time delay control, and δq(k) represents a relative steady-state outflow deviation between water diversion trunk canals of the canal system on two sides of the riverway.

According to a model transformation matrix, one calculation node corresponds to two variables of the water level and the flow rate, and the introduction of a gate boundary term improves a sparsity of the model transformation matrix, corresponding to L and R:

$$L = ( \begin{matrix}{O}_{11} & {O}_{12} & {O}_{13} & 0 \\ {O}_{21} & {O}_{22} & {O}_{23} & 0 \\ {O}_{31} & {O}_{32} & {O}_{33} & 0 \\ 0 & 1 & - {( \frac{\partial f}{\partial {Z}_{j + 1}} )}_{ε} & - {( \frac{\partial f}{\partial {Z}_{j + 2}} )}_{ε}\end{matrix} ) \\ R = ( \begin{matrix}{O}_{11}^{′} & {O}_{12}^{′} & {O}_{13}^{′} & 0 \\ {O}_{21}^{′} & {O}_{22}^{′} & {O}_{23}^{′} & 0 \\ {O}_{31}^{′} & {O}_{32}^{′} & {O}_{33}^{′} & 0 \\ 0 & 1 & - {( \frac{\partial f}{\partial {Z}_{j + 1}} )}_{ε}^{′} & - {( \frac{\partial f}{\partial {Z}_{j + 2}} )}_{ε}^{′}\end{matrix} )$$

A model transformation space formula after processing is written into a general expression of a system state equation:

$$x ( k + 1 ) = {A}_{A} x ( k ) + {B}_{B} u ( k ) \\ {A}_{A} = {L}^{- 1} R \\ {B}_{B} = {L}^{- 1} P$$

In application, a state space of a series water supply-power generation canal is constructed, and a mechanism-driven control scheme is taken as a sample for learning and regression to obtain function parameters of the prediction model, so as to monitor and perceive the prediction and the strategy controlled by the executive mechanism according to a current situation. In an application process, a future situation of the canal system is predicted from the current situation to correspond to the control strategy, and prediction verification is further followed up to continuously predict the evolution of a system device, so as to maintain steady-state operation.

Then, regression and classification are made through a neural network, an input of a multi-point real-time monitoring water level is layered to correspond to a reasonable state in the state space under fuzzy control, so as to form decoupling control of a fuzzy neural network, and a predictive function controller is applied to make a strategy.

Fuzzy control based on a rule is formed, a rule between the input and the output is formulated, and according to the input, an output value may be generated and obtained in real time through rule judgment.

According to the gate linkage control method provided by the embodiment of the present application, the water demand and the current water level information of the series water supply and power generation system are acquired, wherein the current water level information at least comprises the current riverway water level information and the current water diversion trunk canal water level information, the gate opening degree control strategy of the first water diversion gate and the second water diversion gate is determined according to the water demand and the current water level information of the series water supply and power generation system, and the linkage control is carried out on the first water diversion gate and the second water diversion gate according to the gate opening degree control strategy. According to the method provided by the solution above, the gate opening degree control strategy is determined according to the current water demand and the current water level information, so that gate opening degrees of multiple water diversion gates can be controlled according to the gate opening degree control strategy, so as to accurately control the series water supply and power generation system. Moreover, on one hand, the linkage between multiple gates is applied to verify the possibility of ensuring stable operation, which not only realizes deep combination of coarse adjustment and fine adjustment in feedforward and feedback, but also implements deviation control for a steady state, thus further improving the robustness of control. Meanwhile, in combination with advanced control based on model control, overall linkage is formed from single-to-single operation, and in combination with the hydrodynamic model and the large time delay control, a controller is formed according to a corresponding control theory, so as to achieve effects of parallel coarse adjustment and fine adjustment and the cohesion of emergency and daily operation. On the other hand, the linkage between devices is formed, different functions of different devices are used cooperatively, measurement and sensing are used as feedbacks in real time to guide the gate to execute control, and the linkage and cooperation between various gates and different devices in linkage control under different working conditions finally realize the water level stability.

Moreover, a multi-input and multi-output state space of gate linkage control is formed, water level and flow rate values of all measuring points at the same moment are used as multiple inputs, and obtained opening degree control application guidances of all gates are used as multiple outputs, so as to ensure efficient and stable control cohesion between different working conditions. The deep learning is innovatively applied to achieve an optimization method and an operation strategy, and the fuzzy neural network is introduced, which can layer and classify a controlled object, thus further obtaining a correct and reasonable strategy guidance from the state space. The predictive function controller based on the state space model, which is designed on the basis of a predictive function control algorithm principle, is formed.

An embodiment of the present application provides a gate linkage control device, applied to a series water supply and power generation system. The series water supply and power generation system comprises a reservoir, a riverway, an overflow weir and a water diversion trunk canal, one end of the riverway is connected with the reservoir, a first water diversion gate is arranged between the riverway and the reservoir, the riverway is sequentially provided with a tubular hydrogenerator set and the overflow weir in a water flow direction of the riverway, the water diversion trunk canal is arranged in parallel with the riverway in a downstream position of the riverway, and a second water diversion gate is arranged between the water diversion trunk canal and the overflow weir. The gate linkage control device is used for executing the gate linkage control method provided by the above embodiment.

FIG. 3 is a schematic structural diagram of the gate linkage control device provided by the embodiment of the present application. The gate linkage control device 30 comprises an acquisition module 301, a determination module 302 and a control module 303.

The acquisition device is configured for acquiring a water demand and current water level information of the series water supply and power generation system, wherein the current water level information at least comprises current riverway water level information and current water diversion trunk canal water level information; the determination module is configured for determining a gate opening degree control strategy of a first water diversion gate and a second water diversion gate according to the water demand and the current water level information of the series water supply and power generation system; and the control module is configured for carrying out linkage control on the first water diversion gate and the second water diversion gate according to the gate opening degree control strategy.

With regard to the gate linkage control device in this embodiment, specific executing ways of the modules have been described in detail in the embodiment of the method, which will not be described in detail herein.

The gate linkage control device provided by the embodiment of the present application is used for executing the gate linkage control method provided by the above embodiment, and has the same implementation mode and principle, which will not be repeated herein.

An embodiment of the present application provides a series water supply and power generation system, which is used for executing the gate linkage control method provided by the above embodiment.

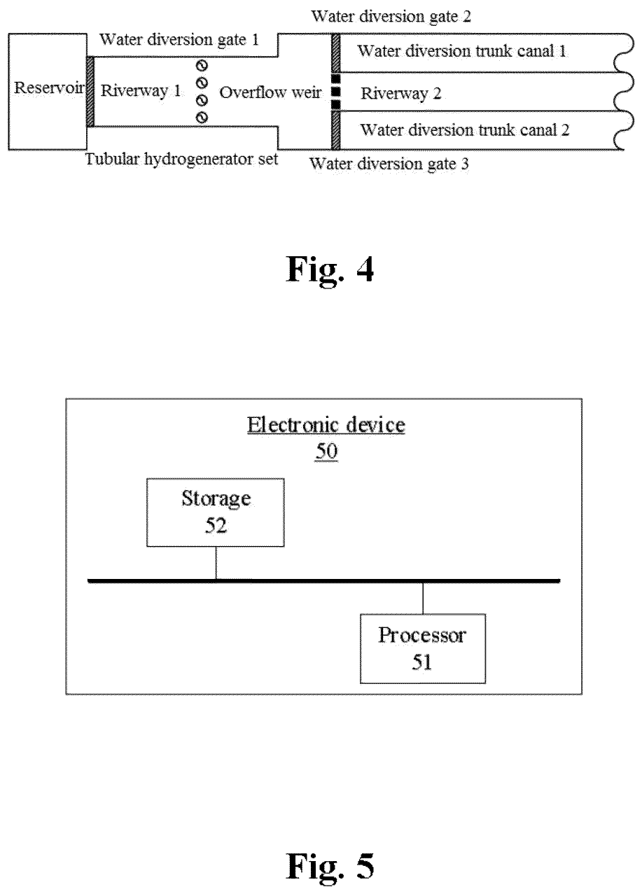

FIG. 4 is a schematic structural diagram of the series water supply and power generation system provided by the embodiment of the present application. The system comprises a reservoir, a riverway (a riverway 1 and a riverway 2), an overflow weir and a water diversion trunk canal, wherein one end of the riverway is connected with the reservoir, and a first water diversion gate (a water diversion gate 1) is arranged between the riverway and the reservoir; and the riverway is sequentially provided with a tubular hydrogenerator set and the overflow weir in a water flow direction of the riverway, the water diversion trunk canal is arranged in parallel with the riverway in a downstream position of the riverway, and a second water diversion gate is arranged between the water diversion trunk canal and the overflow weir. The series water supply and power generation system comprises two water diversion trunk canals (a water diversion trunk canal 1 and a water diversion trunk canal 2 as shown in FIG. 5), the two water diversion trunk canals are located on two sides of the riverway, and are both arranged in parallel with the riverway in the downstream position of the riverway, and the second water diversion gate (a water diversion gate 2 and a water diversion gate 3) is arranged between each water diversion trunk canal and the overflow weir.

The system further comprises an electronic device, and FIG. 5 is a schematic structural diagram of the electronic device provided by the embodiment of the present application. The electronic device 50 comprises at least one processor 51 and a storage 52.

The storage stores a computer executive instruction; and the at least one processor executes the computer executive instruction stored in the storage, so that the at least one processor executes the gate linkage control method provided by the above embodiment.

Specifically, based on an original simple water supply and power generation canal, the overflow weir and other overflow structures are added in a hardware aspect, and when an application deviation or error occurs, a redundant and unusable water flow is discharged to the outside of the canal to supplement the deficiency of automatic control, so as to ensure a standby for a risk such as redundant incoming water. Moreover, an original generator set is improved into several tubular hydrogenerator sets in a row, which can avoid affecting a water supply function even when an individual generator set is shut down for maintenance. Then, considering a possible error in a control operation, an opening degree feedback sensor is added in a position of the gate executive mechanism, and a real opening degree of the gate after the control operation is formed into the feedback to avoid a control difference and superimposed transmission, so as to adapt to the application of linkage control.

Furthermore, the current device is subjected to an optimized design to ensure that the practical requirement of linkage control is met. Considering an influence of water surge in gate opening and closing, a superelevation design for the canal is carried out. Considering discharge capacities under different opening degrees in a process of gate linkage control, an arc gate design is carried out. A location and a layout of the water diversion trunk canal are determined according to actual water supply and water reception, and meanwhile, original natural factors, such as the riverway, a river head and the canal, are utilized. Then, gates are correspondingly designed for water diversion facilities respectively as control means. In addition, the selection and setting of the monitoring station are improved according to a type, so that a flow rate and water level monitoring station is determined, and a precipitation evaporation monitoring station and a soil moisture monitoring station are added according to the situation. It is ensured that the hardware design not only meets an actual engineering application, but also meets the actual requirement of linkage control.

Specifically, the tubular hydrogenerator set is arranged in the riverway in a middle position, which reduces a loss and a disturbance of a water level fluctuation to artificial canal and gate, and also avoids water supply from being interrupted due to shutdown of the generator set for maintenance. Two water diversion trunk canals are respectively arranged on two sides of the riverway to meet a water supply demand, and two water diversion gates are correspondingly arranged in an upstream position. Meanwhile, the overflow weir is arranged between the water diversion gates of the two trunk canals and the riverway to ensure that redundant and unusable incoming water is discharged to a downstream riverway. In addition, monitoring stations and sensors are arranged in appropriate positions, the mounting of monitoring facilities should follow a preset standard, and the stations are arranged in a major middle canal section in positions with similar distances from the two gates and potential safety hazards possibly caused by a rising water level.

Generally, the electronic device provided by the embodiment of the present application carries out linkage control on the water diversion gate based on the method provided by the above embodiment. When a water level of the whole system is lowered, an inflow rate can be increased by increasing an opening degree of an inlet gate of the reservoir and opening the gate of the water diversion truck canal at the same time, so as to raise the water level. When the water level is too high, the opening degree of the inlet gate can be reduced, and an opening degree of an outlet gate can be increased. The situation analysis of actual operation comprises, but is not limited to, that: when the water demand is increased, the water level of the water diversion trunk canal is lowered or a soil moisture content monitored by the soil moisture monitoring station is too low, so that it is necessary to open the water diversion gate in front of the water diversion trunk canal to increase the inflow rate of the water diversion trunk canal, so as to ensure timely and sufficient water supply; when there is too much incoming water, comprising an operation error and a precipitation increase monitored by the precipitation monitoring station, the gate in front of the water diversion trunk canal should be closed, and a downstream water diversion gate of the reservoir should be closed according to the situation, so as to discharge the redundant and unusable incoming water out of the canal through the overflow weir; when the linkage control causes significant water level and flow rate fluctuations, the opening degree of each gate should be adjusted through the feedback adjustment by considering an influence of an interaction between gates based on water level and the flow rate values monitored in real time, so as to ensure the water level and flow rate fluctuations are stable within a specified range; when the generator set fails, because a row of tubular hydrogenerator sets are used for water energy utilization in the embodiment of the present application, the failure of the individual generator set does not affect the water supply, and it is only necessary to maintain the failed generator set; and when an evaporation capacity monitored by the evaporation monitoring station in the canal system is increased, an opening degree of the downstream water diversion gate of the reservoir needs to be increased, so as to increase the incoming water, and a water diversion gate of each water diversion canal is opened, so as to realize water level rising to a steady state.

In order to reflect a performance of the linkage control system in the present invention, a working condition with a flow rate demand of 30 m³/s is designed for a gate control test, and compared with a performance index of a PID control algorithm, and parameters of the control system are preset first, as shown in Table 1.

TABLE 1
Presetting of parameters of control system

| T | N | M | P |
|---|---|---|---|
| 60 | 25 | 4 | 20 |

For the design test, each gate faces the same situation, the same initial conditions are set for each controller, and the following several performance indexes are set respectively:

### (1) Water Level Index

1) Absolute maximum error I_{MAE}:

$${I}_{MAE} = {\sum }_{mi} \frac{max ( \vert {y}_{ti} - {y}_{targeti} \vert )}{{y}_{targeti}} / {N}_{m}$$

wherein, yₙ is an actual water level in an i^{th} canal section at a moment t, y_{targeti} is a target water level in the i^{th} canal section at the moment t, and Nₘ is a total number of canal sections.
2) Error absolute value integral I_{IAE}:

$${I}_{IAE} = {\sum }_{mi} \frac{\frac{Δ t}{( {t}_{2} - {t}_{1} )} {\sum }_{t = {t}_{1}}^{{t}_{2}} \vert {y}_{ti} - {y}_{targeti} \vert}{{y}_{targeti}} / {N}_{m}$$

wherein, t₁ is time when a water flow state begins to change, t₂ is simulation time, Δt is a control time step, the time step remains unchanged within the simulation time, and the index is an integral index and reflects a cumulative amount of errors in a transition process.
3) Steady-state error I_{STE}:

$${I}_{STE} = {\sum }_{mi} \frac{\vert {\overline{y}}_{t 2 i , {t}_{2} - 2 hi} - {y}_{targeti} \vert}{{y}_{targeti}} / {N}_{m}$$

wherein, y̅_{t2i,t}_{₂}₋₂ₕᵢ is an average water depth in the last two hours, I_{STE} calibrates the control accuracy, that is, a difference value between the steady water level and the target water level.

### (2) Flow Rate Index

Flow rate change absolute value integral I_{IAQ}:

$${I}_{IAQ} = {\sum }_{mi} \frac{\frac{Δ t}{( {t}_{2} - {t}_{1} )} ( {\sum }_{t = {t}_{1}}^{{t}_{2}} ( \vert {Q}_{mi} - {Q}_{t 1 i} \vert ) - ( \vert {Q}_{t 1 i} - {Q}_{t 2 i} \vert ) )}{{Q}_{desi}} / {N}_{m}$$

wherein, Qₜ is a discharge flow rate at the moment t, Q_{desi} is a water capacity set for the i^{th} canal section, and I_{IAQ} reflects an adjustment capacity of a gate terminal controller to the discharge flow rate, and is closely related to the time step.

### (3) Gate Operation Index

Gate operation stability and fluctuation performance index I_{IAW}:

$${I}_{IAW} = {\sum }_{{t}_{2}}^{{t}_{2}} ( \vert {W}_{t} - {W}_{t - 1} \vert ) - ( \vert {W}_{{t}_{1}} - {W}_{{t}_{2}} \vert )$$

Wherein, Wₜ is a gate control quantity at the moment t, Wₜ₋₁ is a gate control quantity at a moment t−1, Wₜ, is a gate control quantity at an initial moment, and Wₜ_{₂} is a gate control quantity at an end moment of control. Control results are shown in Table 2.

TABLE 2
Calculation results of various performance indexes

| Performance | PID control | Fuzzy neural network |
|---|---|---|
| index | algorithm | control algorithm |
| I_{MAE} | 4.12E−7 | 1.83E−7 |
| I_{IAE} | 2.33E−7 | 1.59E−7 |
| I_{STE} | 1.66E−4 | 1.57E−4 |
| I_{IAQ} | 1.52 | 1.08 |
| I_{IAW} | 4.13E−6 | 4.49E−6 |

According to comparison of the water level and flow rate indexes, IMAE, IIAE, ISTE and IIAQ of the fuzzy neural network control algorithm provided by the present invention are all smaller than those of the PID control algorithm, thus it can be seen that the water supply-power generation series linkage control method provided by the present invention has performance advantages in control accuracy. Meanwhile, it can be seen from comparison of the gate operation stability index IIAW that the algorithm provided by the present invention has less fluctuation in gate operation, higher operation stability and robustness of dynamic system change, and can effectively deal with nonlinear problems such as gate linkage control in the series water supply and power generation system, thus having a great application prospect.

The electronic device provided by the embodiment of the present application is used for executing the gate linkage control method provided by the above embodiment, and has the same implementation mode and principle, which will not be repeated herein.

An embodiment of the present application provides a computer-readable storage medium, wherein the computer-readable storage medium stores a computer executive instruction, and when executed by a processor, the computer executive instruction implements the gate linkage control method provided in any embodiment above.

The computer-readable storage medium comprising the computer executive instruction according to the embodiment of the present application may be used for storing the computer executive instruction for the gate linkage control method provided by the above embodiment, and has the same implementation mode and principle, which will not be repeated herein.

In the several embodiments provided in the present application, it should be understood that the disclosed device and method may be implemented in other ways. For example, the foregoing device embodiments are only illustrative. For example, the division of the units is only one logical function division. In practice, there may be other division methods. For example, multiple units or assemblies may be combined or integrated into another system, or some features may be ignored or not executed. In addition, the illustrated or discussed mutual coupling or direct coupling or communication connection may be indirect coupling or communication connection through some interfaces, devices or units, and may be in electrical, mechanical or other forms.

The units illustrated as separated parts may be or may not be physically separated, and the parts displayed as units may be or not be physical units, which means that the parts may be located in one place or distributed on multiple network units. Some or all of the units may be selected according to actual needs to achieve the objects of the solutions of the embodiments.

In addition, each functional unit in each embodiment of the present application may be integrated in one processing unit, or each unit may exist alone physically, or two or more units may be integrated in one unit. The integrated units above may be implemented in a form of hardware, or may be implemented in forms of hardware and software functional units.

The integrated units above realized in the form of software functional unit may be stored in a computer-readable storage medium. The software functional unit is stored in one storage medium including a number of instructions such that a computer device (which may be a personal computer, a server, a network device, or the like) or a processor executes a part of steps of the method in the embodiments of the present application. The foregoing storage medium comprises: any medium capable of storing program codes such as a USB disk, a mobile hard disk, a Read-Only Memory (ROM), a Random Access Memory (RAM), a magnetic disk, an optical disk, or the like.

1. A gate linkage control method, applied to a series water supply and power generation system, the series water supply and power generation system comprising a reservoir, a riverway, an overflow weir and a water diversion trunk canal, one end of the riverway being connected with the reservoir, a first water diversion gate being arranged between the riverway and the reservoir, the riverway being sequentially provided with a tubular hydrogenerator set and the overflow weir in a water flow direction of the riverway, the water diversion trunk canal being arranged in parallel with the riverway in a downstream position of the riverway, and a second water diversion gate being arranged between the water diversion trunk canal and the overflow weir, wherein the method comprises the following steps of:
acquiring a water demand and current water level information of the series water supply and power generation system, wherein the current water level information at least comprises current riverway water level information and current water diversion trunk canal water level information;
determining a gate opening degree control strategy of a first water diversion gate and a second water diversion gate according to the water demand and the current water level information of the series water supply and power generation system;
carrying out linkage control on the first water diversion gate and the second water diversion gate according to the gate opening degree control strategy.

2. The method according to claim 1, wherein the determining the gate opening degree control strategy of the first water diversion gate and the second water diversion gate according to the water demand and the current water level information of the series water supply and power generation system, comprises:
determining the gate opening degree control strategy of the first water diversion gate and the second water diversion gate according to water level and flow rate change trend information, the water demand and the current water level information of the series water supply and power generation system, wherein the riverway and the water diversion trunk canal are provided with a plurality of water level monitoring stations, and the water level and flow rate change trend information represents a corresponding relationship between a water level change and a flow rate of each water level monitoring station;
wherein, the water demand at least comprises a target water level of the water diversion trunk canal.

3. The method according to claim 2, wherein the series water supply and power generation system comprises two water diversion trunk canals, the two water diversion trunk canals are located on two sides of the riverway, and are both arranged in parallel with the riverway in the downstream position of the riverway, and the second water diversion gate is arranged between each water diversion trunk canal and the overflow weir, and the determining the gate opening degree control strategy of the first water diversion gate and the second water diversion gate according to the water level and flow rate change trend information, the water demand and the current water level information of the series water supply and power generation system, comprises:
determining a water deficit of the water diversion trunk canal according to the water demand and the current water level information;
determining a primary gate opening degree control strategy of the first water diversion gate and the second water diversion gate according to the water deficit of the water diversion trunk canal and the water level and flow rate change trend information based on a linkage influence among various water diversion gates in the series water supply and power generation system;
acquiring environmental interference information of the series water supply and power generation system;
determining a system error of the series water supply and power generation system according to the environmental interference information;
determining a gate adjustment error according to a gate linkage control result represented by the primary gate opening degree control strategy of the first water diversion gate and the second water diversion gate;
correcting the primary gate opening degree control strategy of the first water diversion gate and the second water diversion gate according to the system error and the gate adjustment error to obtain the gate opening degree control strategy of the first water diversion gate and the second water diversion gate.

4. The method according to claim 3, wherein the method further comprises the following step of:
determining the linkage influence among various water diversion gates in the series water supply and power generation system according to the following formula:
$${K}_{1} ( k + 1 ) = α {K}_{1} ( k ) + β {K}_{2} ( k ) + γ {K}_{3} ( k )$$
wherein, K₁ represents the first water diversion gate, K₂ and K₃ respectively represent two second water diversion gates, K₁(k+1) represents a gate opening degree of the first water diversion gate at a moment k+1, K₁(k), K₂(k) and K₃(k) respectively represent gate opening degrees of the first water diversion gate and the two second water diversion gates at a moment k, and α, β and γ respectively represent flow rate indexes of the first water diversion gate and the two second water diversion gates at the moment k.

5. The method according to claim 3, wherein the determining the gate adjustment error according to the gate linkage control result represented by the primary gate opening degree control strategy of the first water diversion gate and the second water diversion gate, comprises:
predicting the gate linkage control result according to the primary gate opening degree control strategy of the first water diversion gate and the second water diversion gate based on a hydrodynamic model and a large time delay control model of the series water supply and power generation system;
determining the gate adjustment error corresponding to the primary gate opening degree control strategy according to a water level difference between a predicted water level represented by the gate linkage control result and the target water level represented by the water demand.

6. The method according to claim 2, wherein the acquiring the current water level information of the series water supply and power generation system, comprises:
acquiring a current water level monitoring result obtained by each water level monitoring station;
filtering the current water level monitoring result according to water level fluctuation information of the riverway and the water diversion trunk canal to obtain the current water level information of the series water supply and power generation system.

7. The method according to claim 1, wherein the carrying out linkage control on the first water diversion gate and the second water diversion gate according to the gate opening degree control strategy, comprises:
carrying out linkage control on the first water diversion gate and the second water diversion gate according to the gate opening degree control strategy based on a preset canal time delay control model to make a water level of the water diversion trunk canal change stably, wherein the preset canal time delay control model is as follows:
$$\frac{d {c}_{i} ( t )}{d t} = \frac{1}{{A}_{h i}} [ {q}_{jini} ( t - {τ}_{i} ) - {q}_{chui} ( t ) - {q}_{qui} ( t ) ]$$
wherein, cᵢ(t) represents a deviation between an actual water level and a steady water level of a water diversion trunk canal i at a moment t, Aₕᵢ represents a backwater zone area of the water diversion trunk canal i, qⱼᵢₙᵢ, q_{chui} and q_{qui} respectively represent deviations of an inlet flow rate, an outlet flow rate and an intake flow rate corresponding to the water diversion trunk canal i in a steady state, and τᵢ represents a time delay corresponding to the water diversion trunk canal i.

8. A gate linkage control device, applied to a series water supply and power generation system, the series water supply and power generation system comprising a reservoir, a riverway, an overflow weir and a water diversion trunk canal, one end of the riverway being connected with the reservoir, a first water diversion gate being arranged between the riverway and the reservoir, the riverway being sequentially provided with a tubular hydrogenerator set and the overflow weir in a water flow direction of the riverway, the water diversion trunk canal being arranged in parallel with the riverway in a downstream position of the riverway, and a second water diversion gate being arranged between the water diversion trunk canal and the overflow weir, wherein the device comprises:
an acquisition device configured for acquiring a water demand and current water level information of the series water supply and power generation system, wherein the current water level information at least comprises current riverway water level information and current water diversion trunk canal water level information;
a determination module configured for determining a gate opening degree control strategy of a first water diversion gate and a second water diversion gate according to the water demand and the current water level information of the series water supply and power generation system;
a control module configured for carrying out linkage control on the first water diversion gate and the second water diversion gate according to the gate opening degree control strategy.

9. (canceled)
